(19) United States
(12) Patent Application Publication
(10) Pub. No.: US 2007/0284269 A1
(43) Pub. Date: Dec. 13, 2007

(54) Voice recording gift card holder

(75) Inventor: Scott L. Star, New York, NY (US)

Correspondence Address: Gerard F. Dunne, Suite 1223, 156 Fifth Avenue, New York, NY, 10010, US

(73) Assignee: E&B Giftware, LLC., Yonkers, NY (US)

(21) Appl. No.: 11/788,025

(22) Filed: Apr. 18, 2007

Related U.S. Application Data
(60) Provisional application No. 60/792,923, filed on Apr. 18, 2006.

(51) Int. Cl. G09F 1/00; G09F 1/10; B65D 85/00

(52) U.S. Cl. 206/307; 40/124.03; 40/124.06

(57) ABSTRACT

A holder for a gift card of the type for recording a monetary amount for a gift to enable a purchase by the recipient, includes electronics enabling a voice message to be recorded by the purchaser of the gift card. The voice message can then be played back by the recipient upon first removal of the card from the holder or by actuating a switch to eject the card from the holder. Upon return of the card to the holder, a speech synthesizer may be provided to state the amount remaining on the card when it is inserted into the holder.

### PRIOR APPLICATION

This application is based on provisional application No. 60/792,923 filed Apr. 18, 2006, and claim is made for the benefit of the filing date of the provisional application.

### FIELD OF THE INVENTION

The present invention relates to a holder for a gift card that may record a message from the person giving the gift card that may be played by the receiver.

### BACKGROUND OF THE INVENTION

Gift cards are becoming increasing popular and are typically provided by a retail store in much of the manner of a gift certificate. The gift card is encoded with an amount of money representing purchases that may be made at the retail store, and the recipient may then use the encoded gift card to make purchases. Often the amount of the purchase when the card is used is deducted from the value on the card so the card may again be used at a later date.

Such gift cards may be considered somewhat impersonal when compared with an actual gift, but have gained acceptance in that they may be mailed easily, are convenient to use and, unlike gift certificates, the value of the card can be modified as purchases are made, or value can be added later if desired.

### SUMMARY OF THE INVENTION

According to the present invention, a gift card is made more personal by providing a holder for the card have electronics enabling a voice message to be recorded by the purchaser of the gift card, and then played back by the recipient upon first removal of the card from the holder or by actuating a switch. Upon return of the card to the holder, a speech synthesizer may be provided to state the amount remaining on the card when it is inserted into the holder.

These and other objects, advantages and features of the present invention will. become apparent from the description given below of a preferred embodiment, which description is made in conjunction with the following drawing figures.

### BRIEF DESCRIPTION OF THE DRAWINGS

FIG. 1 is a simplified perspective of a holder of the present invention for a gift card;

FIG. 2 is a plan view of the of a gift card holder according to the present invention;

FIG. 3 is a sectional view of the gift card holder according to the present invention;

FIGS. 4 through 9 illustrate sectional views of the gift card holder of FIG. 3 along the sectional lines shown in FIG. 3.

FIG. 10 is an explodes view of the present invention.

### DETAILED DESCRIPTION OF A PREFERRED EMBODIMENT

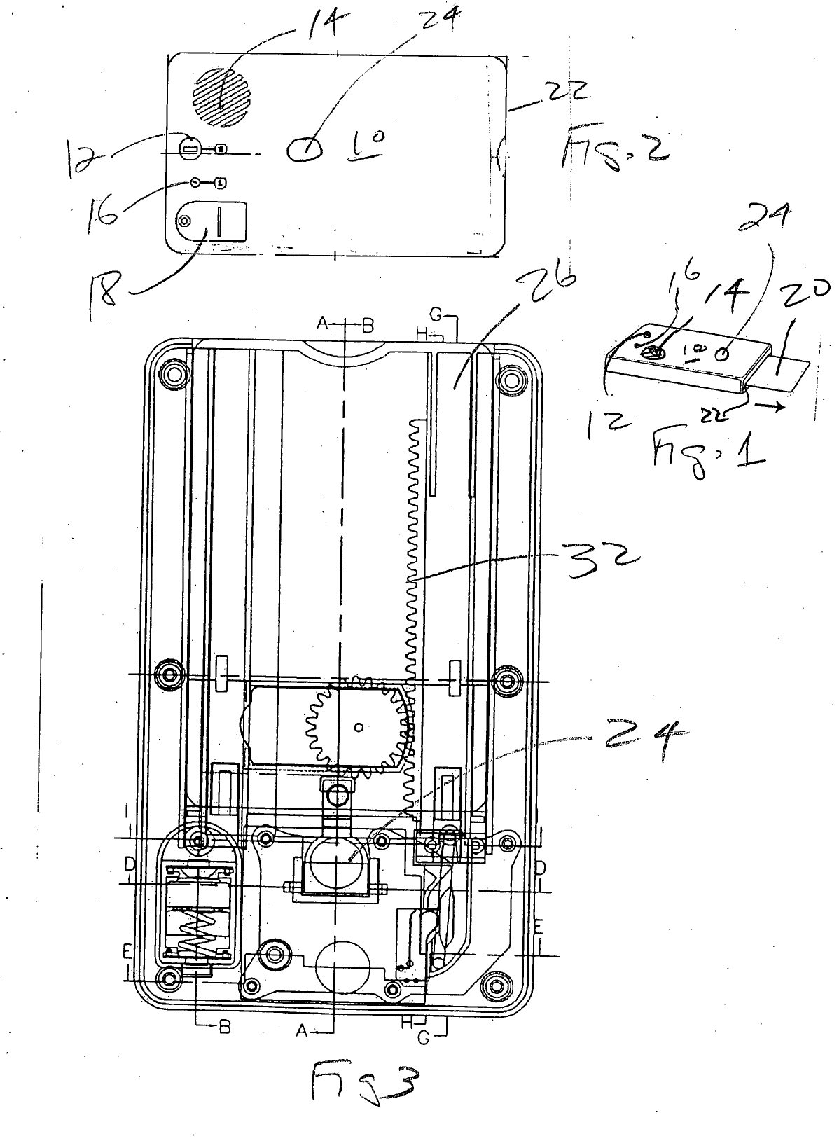

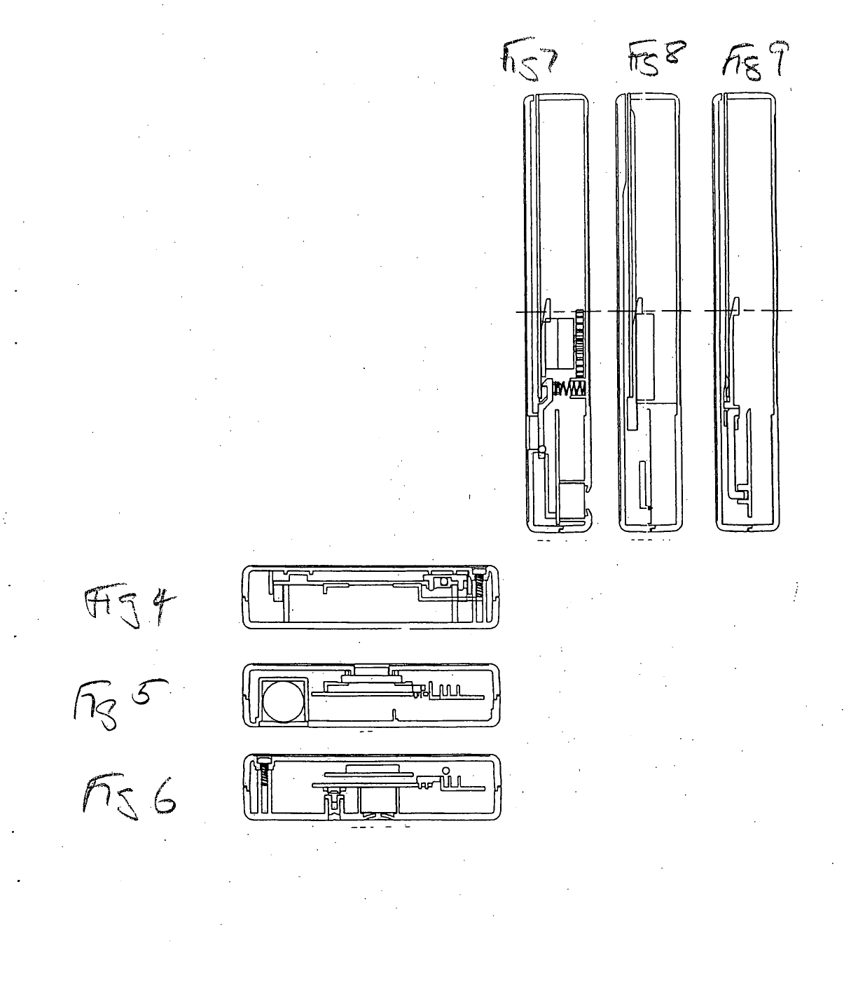

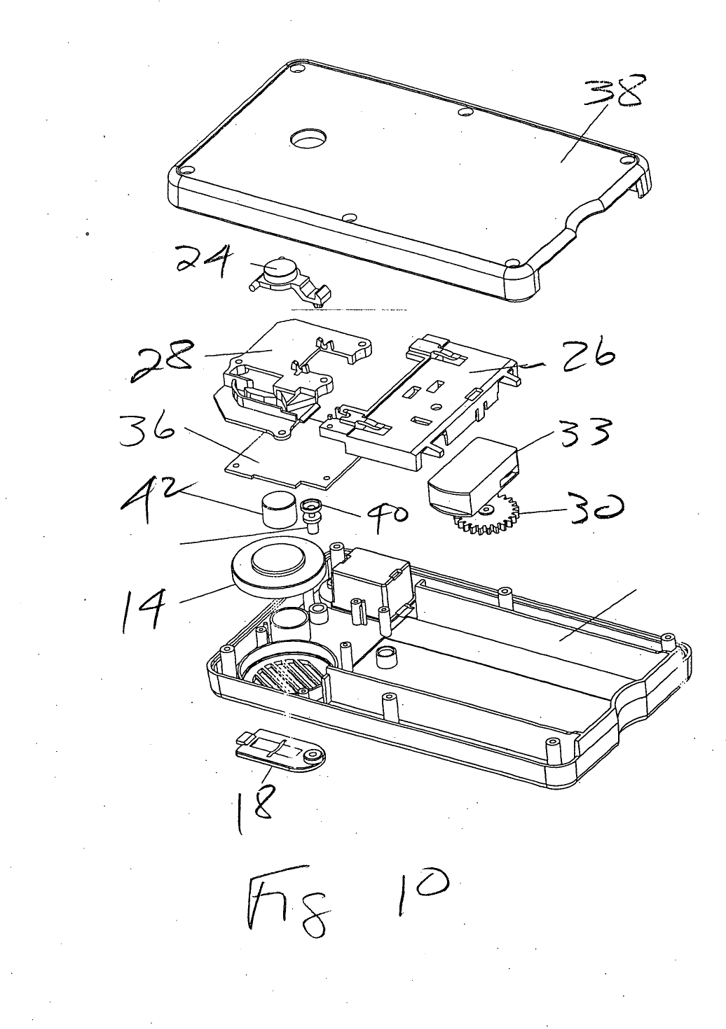

A holder 10 as shown in FIGS. 1 and 2 may include a decorative motif representing a holiday season or similar motif suitable for the packaging of a gift. Alternatively, the motif could include the name and message from a retail store in which the gift card to be inserted into the holder may be redeemed. The holder 10 contains circuitry including a microphone 12, speaker outlet 14 and recording actuation switch 16 located on the surface of the holder. A battery access 18 is also provided.

As will be understood, a purchaser of a gift card 20 will receive the holder and may actuate switch 16 to enable a message or greeting to be recorded on a recording chip. The gift card can be inserted into opening 22 of the holder 10, and the holder can be designed so that the recipient may press actuation button 24 to slowly eject the gift card and play back the recorded message, or the recorded message can be played back automatically as the gift card is removed from the holder by the recipient.

As shown in FIGS. 3 and 10, the holder 10 includes a card-receiving carrier 26 supported by frame 28 to receive the gift card. A gear 30 and rack 32 contained in housing 33 are provided to drive the carrier 26 upon receiving a signal upon actuation of button 24 to eject the gift card. The electronic circuitry on pcb board 36 will play the recorded message through the speaker 14 as the card is ejected from the holder 10.

To record a message, a pointed object may be inserted in an opening in the top cover 38 to actuate switch element 40 to record a message spoken into microphone 42. The circuitry operates to enable one making the voice recording to hear the recorded message by pressing actuation button 24, much in the manner of a recording made on a conventional answering machine.

As a added feature, when the card is returned to the holder, the circuitry and programming may include a speech synthesizer to provide an audio signal stating the amount of purchases that may be made by subsequent use of the card. In this way, the user will continually be advised of the amount remaining on the card after use. Additionally, the circuitry and programming may enable additional amounts to be added to the gift card, or the card can be set at an amount certain upon purchase at a participating store.

These and other objects, advantages and features of the present invention will be understood from the detailed description of a preferred embodiment made above; however, the present invention is not limited by any details of the above but is set forth by the appended claims.

What is claimed is:

1. A holder for a gift card having coded information representing an amount that may be used to purchase one or more gifts, including a switch on the holder activating a record mechanism to enable a purchaser of the gift card to record a message, and a second switch enabling a gift card to be ejected from the holder while replaying the recorded message.

2. A holder for a gift card as set forth in claim 1, further including a sensor capable of reading the coded information on the gift card and a speech synthesizer to provide an audio of the amount remaining on the card when it is inserted into the holder.
